(19) United States
(12) Patent Application Publication
(10) Pub. No.: US 2012/0223001 A1
(43) Pub. Date: Sep. 6, 2012

(54) FILTER AND CENTER TUBE WITH HELICAL FIN

(75) Inventor: John H. Beard, Kearney, NE (US)

(73) Assignee: Baldwin Filters, Inc., Kearney, NE (US)

(21) Appl. No.: 13/040,758

(22) Filed: Mar. 4, 2011

(51) Int. Cl. B01D 29/11; B01D 29/58

(52) U.S. Cl. 210/232; 210/456; 210/433.1; 210/256; 210/457

(57) ABSTRACT

An apparatus and method for filtering a liquid utilize a filter apparatus including a center tube or flow balancing element including a helical fin. The helical fin radially contacts and supports the inner periphery of a filter media. The helical fin may be formed on a venturi center tube, or on a center tube flow balancing element for dividing the total flow of fluid through the filter apparatus into a bypass filter portion and a full-flow filter portion. The helical fin may alternately be formed on a standpipe center tube, defining a helical flow path between the inner periphery of a filter media and openings in the wall of the center tube.

### FIELD OF THE INVENTION

This invention relates to an apparatus and method for filtering impurities from liquids, such as lubricating oil, hydraulic fluid and the like. More particularly, the invention relates to filtering impurities using a filter having a center tube with one or more fins supporting a filter media with the fins providing for at least one flow channel.

### BACKGROUND OF THE INVENTION

A spin-on filter is designed for a specified service life. The filter is then discarded and replaced with a new filter. Typically, more than one manufacturer produces filters which are interchangeable. For filters providing lubrication oil to an engine which will need to be started at cold ambient temperatures, it is also important to select a filter that has a low flow resistance during cold start conditions, so that an adequate flow of filtered lubricant can be supplied while the engine is coming up to operating temperature. Thus, reduction of the number of components of a cartridge filter and decreased flow resistance are desired.

In order to provide a high overall filtering efficiency of the filter, it is a common practice to incorporate two separate filtering elements within a common housing of the spin-on filter. Typically, one of these filters, known as the full-flow filter, is used for filtering all or most of the fluid passing through the housing of the filter. The other filter element, known in the industry as a bypass filter, is used for performing a higher efficiency filtration of a portion of the fluid passing through the housing.

Typically, prior filters of this type have included a venturi tube that is used to locally reduce the pressure in the fluid, at a strategic point within the housing, to aid in pulling a small portion (about 10%) of the fluid through the relatively dense bypass filter. The reduced pressure is created by directing most of the fluid flowing through the housing through a throat in the venturi tube, to thereby accelerate the fluid at the throat of the venturi tube. This acceleration of the fluid causes the fluid pressure at the throat of the venturi tube to drop, due to well known principles of fluid dynamics.

In filters of this type, one or more cylindrical filter media may be disposed surrounding a hollow center volume, and fluid is filtered by passage from the exterior of the media to the interior of the media. In such an arrangement, it is often necessary to provide structural support for the filter media to resist inward collapse in response to a pressure differential across the filter media. In one approach to supporting the filter media, a perforated support tube may be positioned at the inner diameter of the filter media, for example as disclosed in U.S. Patent Publication 2009/0261029 to Fisher.

In another approach, a central standpipe or venturi tube may be provided with axial ribs supporting circumferential filter reinforcing members, as disclosed in U.S. Patent Publication 2010/0044298 to South et al. In such an arrangement, the axial ribs define distinct fluid filtration zones which may result in differential filtration rates through the filter media and reduced filter life.

The invention provides such a filter. These and other advantages of the invention, as well as additional inventive features, will be apparent from the description of the invention provided herein.

### BRIEF SUMMARY OF THE INVENTION

In one aspect, the invention provides a fluid filter assembly comprising a tubular ring of filter media and a center tube. The center tube has an annular wall defining an internal axial flow passage, a flow inlet through the cylindrical wall, and a first opening at an end of the center tube. Fluid is adapted to flow radially through the tubular ring of filter media, through the flow inlet, and along the internal axial flow passage. At least one fin is integrally formed and unitary with the center tube and projecting radially outwardly from the cylindrical wall. Each of said at least one fin covers and is in contact with the annular wall over an angular span about the axial flow passage of at least 30 degrees, such that the at least one fin has an outer peripheral surface radially supporting an inner periphery of the tubular ring of filter media.

In another aspect, the invention provides a fluid filter assembly comprising a first tubular ring of filter media, the first tubular ring of filter media having an inner diameter, a center tube, the center tube having a wall defining a first center cavity, a flow inlet in the wall, and a first open end. The fluid filter assembly also comprises a helical fin, the helical fin having an outer diameter configured to radially outwardly support the first filter media at the inner diameter. The helical fin extends outward from the wall, and the helical fin defines a helical fluid channel between the filter media at the inner diameter and the flow inlet.

In yet another aspect, the invention provides a fluid filter assembly comprising a tubular ring of filter media and a center tube, the center tube having an annular wall defining an internal axial flow passage, a flow inlet through the cylindrical wall, and a first opening at an end of the center tube. Fluid is adapted to flow radially through the tubular ring of filter media, through the flow inlet, and along the internal axial flow passage. At least two fins are integrally formed and unitary with the center tube projecting radially outwardly from the cylindrical wall. The at least two fins are in a spaced apart relation without additional intervening structure between the outer peripheries of the fins, and the at least two fins are supported and indirectly connected through the material of the center tube. Each of the at least two fins have an outer peripheral surface radially supporting an inner periphery of the tubular ring of filter media.

Other aspects, objectives and advantages of the invention will become more apparent from the following detailed description when taken in conjunction with the accompanying drawings.

### BRIEF DESCRIPTION OF THE DRAWINGS

The accompanying drawings incorporated in and forming a part of the specification illustrate several aspects of the present invention and, together with the description, serve to explain the principles of the invention. In the drawings:

FIG. 1 is a perspective cross-sectional view of a filter of the present invention;

FIG. 2 is a detail of a perspective cross-sectional view of a filter of the present invention, showing flow paths through the filter element;

FIG. 3 is an exploded perspective view of a filter cartridge having a center tube with helical fins of the present invention;

FIG. 4 is a cross-sectional view of a second embodiment of a filter of the present invention;

FIG. 5 is a detail of a cross-sectional view of a second embodiment of a filter of the present invention, showing flow paths through the filter element; and

FIG. 6 is a perspective view of a center tube having a helical fin and filter of the present invention;

FIG. 7 is a graph showing the flow rate versus pressure of an cartridge filter of the present invention compared to a prior art cartridge filter.

While the invention will be described in connection with certain preferred embodiments, there is no intent to limit it to those embodiments. On the contrary, the intent is to cover all alternatives, modifications and equivalents as included within the spirit and scope of the invention as defined by the appended claims.

### DETAILED DESCRIPTION OF THE INVENTION

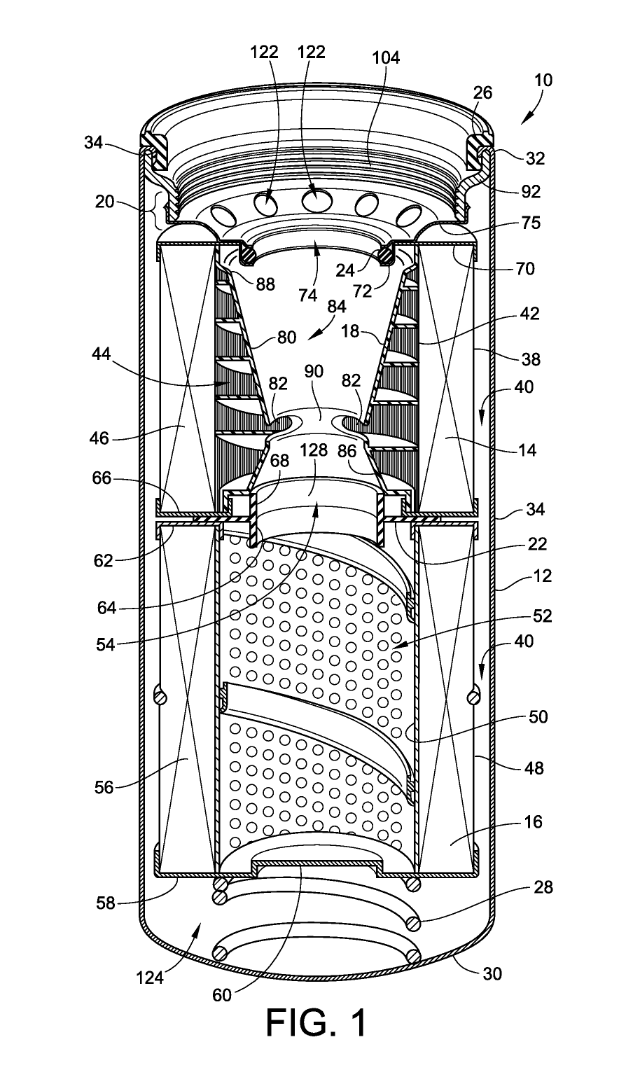

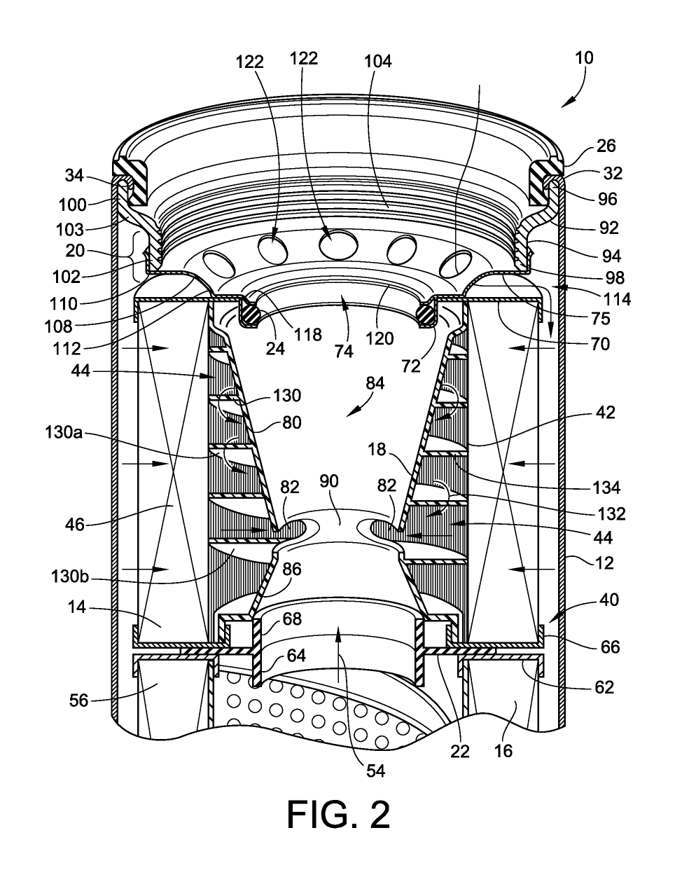

FIGS. 1-2 show a first exemplary embodiment of the present invention, in the form of a spin-on filter 10. Referring to FIG. 1, filter 10 includes a housing 12 enclosing a bypass filter 14 and a full-flow filter 16, a venturi or center tube 18, a spacer 20, an intermediate seal 22, an outlet seal 24, an inlet seal 26, and a helical compression spring 28.

Housing 12 has a closed end 30 and an open end 32, joined by a cylindrical sidewall 34 defining a longitudinal axis 36 extending from the closed end 30 to the open end 32 of the housing 12. Spin-on filter 10 is shown in a vertical mounting configuration, where closed end 30 is at the bottom of the filter 10 and the open end 32 is at the top of filter 10. However, spin-on filter 10 may be mounted in any orientation.

A bypass filter 14 is disposed within the housing 12 at a point along the longitudinal axis 36 adjacent the open end 32 of the housing 12. The bypass filter 14 has an outer periphery 38 that is spaced inward from the sidewall 34 of the housing 12, to form a space 40 around the bypass filter 14. Space 40 allows for passage of fluid between the bypass filter 14 and the sidewall 34. The bypass filter 14 also has an inner periphery 42 defining an axially oriented through-bore 44 of the bypass filter 14, which is centered about the longitudinal axis 36. A bypass filter media 46 is disposed between the inner and outer peripheries 42, 38 of the bypass filter 14. The bypass filter media 46 has a rated bypass filter efficiency, for removing particles of a given size from a fluid flowing radially inward through the bypass filter media 46, from the space 40 around the bypass filter 14 to the through-bore 44 with bypass filter 14.

A full-flow filter 16 is disposed within the housing 12, adjacent the closed end 30, and has an outer periphery 48 that is spaced inward from the sidewall 34 of the housing 12, to form a continuation of the space 40 around the bypass filter 14 and to thereby provide a space 40 around the full-flow filter 16, for passage of fluid between the full-flow filter 16 and the sidewall 34 of the housing 12. The space 40 between the full-flow filter 16 and the sidewall 34 is connected in sealed fluid communication with the space 40 between the bypass filter 14 and the sidewall 34 of the housing 12. The term “full flow” is intended to mean that it may accommodate full flow but typically 70-90% of flow in operation due to the bypass filter. Full flow filter 16 is a more open and permeable media for trapping larger particulates than the bypass filter 14. It should also be noted that most of the flow will therefore bypass the bypass filter 14, and flow through the full flow filter 16.

The full-flow filter 16 has an inner periphery 50 thereof defining an axially oriented through-bore 52 of the full-flow filter 16. The through-bore 52 of the full-flow filter 16 is connected in sealed fluid communication with the through-bore 44 of the bypass filter 14 by an opening 54 the intermediate seal 22, when the intermediate seal 22 is sandwiched between the bypass and full-flow filters 14, 16, in the manner shown in FIGS. 1 and 2. The full-flow filter 16 further includes a full-flow filter media 56 is disposed between the inner and outer peripheries 50, 48 of the full-flow filter 16, and has a rated full-flow filter efficiency, for removing particles of the given size from a fluid flowing radially inward through the full-flow filter media 56 from the annular space 40 around the full-flow filter 16 to the through-bore 44 of the full-flow filter 16, with the bypass filter efficiency being higher than the full-flow filter efficiency for removing particles of the given size.

A center tube 18 is disposed within the through-bore 44 of the bypass filter 16 for balancing the flows of fluid through the bypass filter 14 and full-flow filter 16. In the embodiment show, center tube 18 is a flow balancing element, as disclosed in U.S. Patent Publication 2009/0261029, which is hereby incorporated by reference in its entirety. In another embodiment, center tube 18 is a venturi tube. The center tube 18 may be formed of a plastic material, such as a thermoplastic, a composite material, or metal. Preferably, the center tube (along with the helical fins) are molded as a single unitary plastic component part, and thereby integrally formed.

The full-flow filter 16 includes a lower end plate 58 thereof, adjacent the closed end 30 of the housing 12. The lower end plate 58 is attached to the lower end of the full-flow media 56, and extends generally from the outer periphery 48 to the inner periphery 50 of the full-flow filter 16. The lower end plate 58 also includes an imperforate center section 60 thereof, which blocks fluid flow from entering the through-bore 52 of the full-flow filter 16. The full-flow filter 16 also includes an upper end plate 62 thereof, attached to the upper end of the full-flow filter media 56 adjacent the bypass filter 14, extending generally inward from the outer periphery 48 of the full-flow filter 16, and terminating in a centrally located annular collar, defining an outlet 64 of the through-bore 52 of the full-flow filter 16.

The bypass filter 14 includes a lower end plate 66 thereof, attached to the lower end of the bypass filter media adjacent the upper end plate 62 of the full-flow filter 16, extending generally inward from the outer periphery 38 of the bypass filter 14 and terminating in a centrally located annular collar that defines a full-flow inlet 68 of the bypass filter 14. The juncture between the through-bores 52, 44 in the full-flow and bypass filters 16, 14 is sealed by the intermediate seal 22, which is compressed between the upper end plate 62 of the full-flow filter 16 and the lower end plate 66 of the bypass filter 14. The intermediate seal 22 also engages the collars around the outlet 64 of the full-flow filter 16 and the full-flow inlet 68 of the bypass filter 14, to provide sealed fluid communication between the outlet 64 the full-flow inlet 68, through the opening 54 in the intermediate seal 22.

The bypass filter 14 also includes an upper end plate 70 thereof, attached to the end of the bypass filter media 46 adjacent the open end 32 of the housing 12. The upper end plate 70 of the bypass filter 14 extends generally inward from the outer periphery 38 of the bypass filter 14 and terminates in an annular cup 72, having a hole in the bottom thereof that defines an outlet 74 of the through-bore 44 of the bypass filter 14. The outlet 74 of the through-bore 44 of the bypass filter 14 also serves as the filter outlet for the exemplary embodiments of the spin-on filter 10 disclosed herein.

As shown in FIGS. 1 and 2, the outlet seal 24 is mounted in the annular cup 72, and is held in place by a spacer 75 of the base plate and spacer apparatus 20. The outlet seal 24 is positioned by the annular cup 72 to seal against an outlet tube, as is generally known in the spin-on filter art. Various mounting configurations can be employed with the cartridges described herein. Indeed, the particular advantages and structural configurations of the filter elements described herein are not dependent on or limited by any particular mounting style. For example, the mounting adaptor shown in U.S. Patent Publication 2009/0261029 may be used in conjunction with the cartridge of the present invention.

As shown in FIG. 1, the center tube 18 includes a generally imperforate wall 80 that is spaced from the inner periphery 42 of the bypass filter 14 and extends between the lower and upper end plates 66, 70 of the bypass filter 14, the wall 80 defining a center bore 84. The open ends of the wall 80 are sealingly connected to the full-flow inlet 68 of the bypass filter 14 and to the outlet 74 of the through-bore 44 of the bypass filter 14. The generally imperforate wall 80 of the center tube 18 also defines one or more through-holes therein, that form one or more bypass flow inlets 82 of center tube 18, thereby providing fluid communication between through-bore 44 and center bore 84. In one embodiment, two bypass flow inlets 82 are provided in wall 80 of center tube 18. Bypass flow inlets 82 define an equivalent bypass flow restricting orifice of the flow balancing apparatus 18, which is sized to restrict fluid flow through the bypass filter media 46 and into center bore 84, to a desired bypass flow portion of a total inlet flow of fluid to the filter apparatus 10.

The center tube 18 also includes a full-flow inlet 86 thereof, that mates with and receives fluid from the full-flow inlet 68 of the bypass filter 14. The center tube 18 further includes an outlet 88 that mates with the outlet 74 of the through-bore 44 of the bypass filter 14.

An annular section 90 of the imperforate wall 80 of the center tube 18, disposed about the bypass flow inlets 82 of the center tube 18, defines a full-flow restrictor 90. The full-flow restrictor 90 is sized to restrict the portion of fluid flowing through the full-flow media 56 and into the full-flow inlets 68, 86 of the bypass filter 14 and center tube 18, to a desired full-flow portion of a total inlet flow of fluid to the filter apparatus 10. In another embodiment, annular section 90 is sized to act as a the throat of a venturi, causing a pressure drop at bypass flow inlets 82 in response to the flow of fluid from the full-flow inlet 68 through the annular section 90.

As best seen in FIG. 2, the base plate and spacer apparatus 20 of the spin-on filter 10 includes a base plate 92 and the spacer 75. The base plate and spacer apparatus 20 is operatively attached between the open end 32 of the housing 12 and the upper end plate 70 of the bypass filter 14, and performs several functions including positioning the bypass and full-flow filters 14, 16 within the housing 12 and adapting the filter apparatus 10 for spin-on attachment to a filter mounting adapter (not shown).

The base plate 92, in the exemplary embodiment, includes an annular wall 94 defining an upper edge 96 and a lower edge 98 of the base plate 92, with the upper edge 96 of the base plate 92 being joined to the open end 32 of filter housing 12. In the exemplary embodiment, a portion of the sidewall 34 of the housing 12, adjacent the open end 32 of the housing 12, is formed or rolled over the upper edge 96 of the base plate 92, to thereby join the base plate 92 to the housing 12 with a so-called “J-lock” connection. In other embodiments of the invention, however, the base plate 92 may be joined to the open end 32 of the housing 12 by other types of connections.

The annular wall 94 of the base plate 92 of the first exemplary embodiment is imperforate, but the base plates of other embodiments of the invention may include holes for the passage of fluid. The annular wall 94 in the exemplary embodiment includes a first, a second, and a third wall section 100, 102, 103. The first wall section 100 includes the upper edge 96 of the base plate 92, and has an outer diameter that is generally equal to an inner diameter of the sidewall 34 of the housing 12. The first and second sections 100, 102 of the annular wall 94 of the base plate 92 are joined by the third wall section 103. The second wall portion 102 has an inner surface that is somewhat smaller in diameter than the outer diameter of the first wall section 100, and includes female threads 104 for engagement to a filter mounting adaptor, for attaching the spin-on filter 10 to a filter mounting adapter. The inlet seal 26 seals the juncture of the open end 32 of the housing 12 with a seal surface when the spin-on filter 10 is attached to a mounting adapter.

Still referring to FIG. 2, spacer 75, in the exemplary embodiment, includes an annular wall 108 extending between the lower edge 98 of the base plate and the upper end plate 70 of bypass filter 14, and defining an upper end 110 and a lower end 112 of the spacer 75. The upper end 110 of the spacer 75 and the lower edge 98 of the base plate 92 are configured to fit together tightly enough to prevent fluid from flowing between upper end 110 of the spacer 75 and the lower edge 98 of the base plate 92.

The lower end 112 of the spacer 75 is attached to the upper end plate 70 of the bypass filter 14, and defines an annular flange 118 that protrudes into the annular cup 72 in the upper end plate 70 of the bypass filter 14. Annular flange 118 retains the outlet seal 24 within the annular cup 72. The annular flange 118 forms a hole 120 in the lower end 112 of the spacer 75, for passage therethrough of an outlet tube of a filter mounting adapter. The outlet seal 24 seals outlet 74 from fluid communication with the outside surfaces of base plate 92 and annular wall 108.

The annular wall 108 of the exemplary embodiment of the spacer 75 also defines a plurality of circumferentially spaced inlet flow passageways 122 that provide fluid communication between inside and outside surfaces of the base plate 92 and spacer 75. The inlet flow passageways 122 in the spacer 75, in combination, define a filter inlet that allows fluid to flow from a filter mounting adapter into the inlet plenum 114 of filter housing 12. Inlet plenum 114 of filter housing 12 is in fluid communication with space 40. In other embodiments of the invention, however, the annular wall 108 of the spacer 75 may be imperforate, and other provisions made for allowing entry fluid into the filter housing 12.

The spring 28 of the filter apparatus 10 is compressed between the closed end 30 of the housing 12, and the lower end plate 58 of the full-flow filter 16, to provide an axially directed force for axially positioning the bypass and full-flow filters 14, 16, with respect to the base plate and spacer apparatus 20, and to maintain the seal between the bypass and full-flow filters 14, 16 provided by the intermediate seal 22.

A total inlet flow of fluid to be filtered is supplied into the spin-on filter 10 by the inlet flow passageways 122 in the spacer 75 into inlet plenum 114 and further into the space 40 between the sidewall 34 of the housing 12 and the outer peripheries 38, 48 of the bypass and full-flow filters 14, 16. The incoming fluid also flows into and fills the space 124 adjacent the closed end 30 of the housing 12, around the spring 28, between the lower end plate 58 of the full-flow filter 16 and the closed end 30 of the housing 12, so that the entire volume within the housing 12 and outside of the bypass and full-flow filters 14, 16 is filled with the incoming fluid to be filtered.

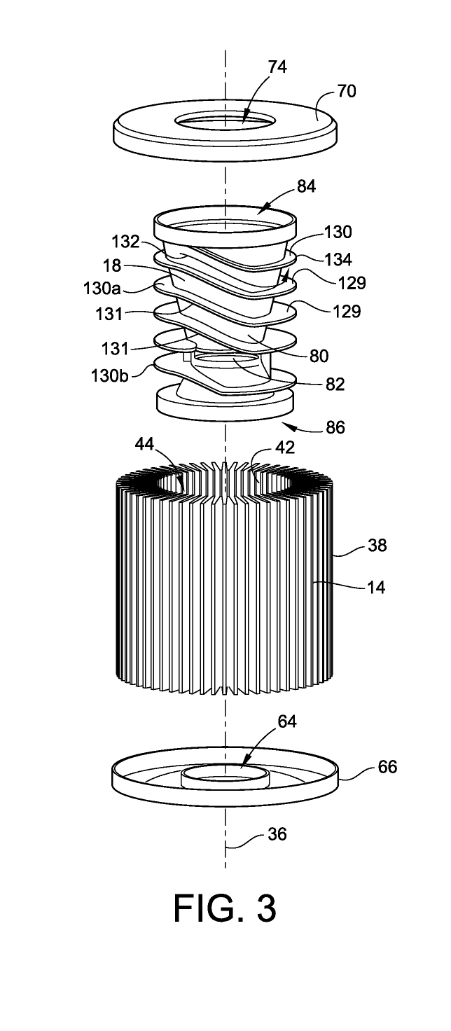

As best shown in FIG. 3, center tube 18 is provided with a helical fin structure 130 that may comprise at least two fins including an upper fin 130a and a lower fin 130b. These upper and lower fins 130a and 130b may each lead to the flow inlet and thereby may be not connected at their outer peripheries but instead only indirectly connected through the support of the center tube 18. Each fin may extend at least 30 degrees around the central axis and axial passage of the filter (thereby covering and being connected to the same angular span of the outside of the center tube) and typically at least 90 degrees, and most typically 1 or more complete wraps around the center tube. While each fin may be horizontally flat and thereby perpendicular to the axis (note flat regions 129 of helical fin structure 130), each fin preferably has a radial and axial component to its span.

Helical fin structure 130 of center tube 18 extends from the variable radial inner diameter of wall 80 to an outer edge 134 of helical fin 130 so as to support the inside of the filter media. In a preferred embodiment, outer edge 134 of helical fin structure 130 is positioned at a constant radius from longitudinal axis 36 of housing 12, and adjacent to the inner periphery 42 of bypass filter 14. As shown, helical fin structure 130 includes substantially flat portions 129, the substantially flat portions 129 being disposed generally perpendicular to the longitudinal axis 36, and helical fin structure 130 further includes one or more sloped portions 131 connecting adjacent flat portions 129. In another embodiment, helical fin structure 130 may describe a substantially smooth curve having a constant slope. As such, “helical” as used herein is meant to be broad to encompass both embodiments (e.g. a helical structure may spiral generally but include flats or discontinuous regions).

The outer edge 134 of helical fin structure 130 radially outwardly contacts and supports the inner periphery 42 of bypass filter 14, thereby supporting bypass filter 14 against radially inward collapse in response to a fluid pressure differential between space 40 and through-bore 44. As shown, helical fin structure 130 is configured to support the inner periphery 42 of filter media 14 without axial ribs or additional support structures. The radial outward support provided by helical fin structure 130 to inner periphery 42 of the bypass filter 14 reduces or eliminates the need for a separate support, such as a perforated center tube or an inner screen, located at the inner periphery 42 of bypass filter 14.

As shown in FIG. 2, helical fin structure 130 defines a helical flow path 132 within the through-bore 44 of bypass filter 14. Helical flow path 132 is in fluid communication with the bypass flow inlets 82, thereby channeling fluid filtered through the bypass filter 14 and into through-bore 44 into the bypass flow inlets 82.

In a preferred embodiment of the present invention, helical fin structure 130 is integrally formed with wall 80 of center tube 18. As shown, helical fin 132 continuously extends from the outlet 88 to the inlet 86 of center tube 18, and helical fin structure 130 is generally imperforate. In other embodiments, helical fin structure 130 may be discontinuous and may be perforated, thereby providing both a helical flow path and other fluid flow paths.

In a preferred embodiment, center tube 18 is provided with a single helical fin 130. However, center tube 18 may alternately be provided with two or more helical fins, together defining two or more fluid flow paths, each providing fluid communication between inner periphery 42 of bypass filter 14 and bypass flow inlets 82. In such a configuration, a plurality of helical fins would form a double helix, triple helix, etc.

As shown in FIG. 1, the inner periphery 50 of the full-flow filter 16 is perforated to allow the incoming fluid to flow radially inward through the media 56 of the full-flow filter 16 from the space 40 around the outer periphery 48 of the full-flow filter 16, into the through-bore 52 of the full-flow filter 16. The portion of the fluid passing through the full-flow filter 16 exits the through-bore 52 of the full-flow filter 16 through the outlet 64 of the full-flow filter 16, and enters the full-flow inlet 86 of the center tube.

As shown in FIG. 2, the portion of the fluid passing through the bypass filter 14 is channeled by helical fin structure 130 of the bypass filter 14 to the bypass flow inlets 82 in the center tube 18. The combined portions of flow passing through the full-flow filter 16 and the bypass filter 14 are then joined into a common total outlet flow of filtered fluid, that exits the spin-on filter 10 through opening 74.

The proportions of the total inlet flow that pass through each of the bypass and full-flow filters 14, 16 is primarily determined by the size of the bypass flow inlets 82 and the flow restrictor 90 of the center tube 18, in conjunction with the operating characteristics of the medias 46, 56 of the bypass and full-flow filters 14, 16.

The media efficiency ratings and desired proportions of the total inlet flow, described above in relation to the exemplary embodiment of the spin-on filter 10, together with the particular configuration and arrangement of the components in the exemplary embodiment of the spin-on filter 10, were judiciously and purposefully selected to provide a filter apparatus having lower resistance to fluid flow during cold start operation than prior spin-on filter of this type, and to provide a larger capacity for holding removed contaminants than prior spin-on filters of this type, while still providing a high overall filtering efficiency. Having a lower resistance to fluid flow during cold-start operation is advantageous in that, for an engine lubrication system, better lubrication can be provided to the engine during cold-start operation. Having a higher capacity for holding removed contaminants is advantageous in that the interval between filter changes can be lengthened, thereby reducing operational costs for the system protected by the filter apparatus.

Those skilled in the art will recognize, however, that in other embodiments of the invention it may be desirable to utilize bypass and full low medias having different efficiency ratings and/or change the configuration of the center tube, or other components of the filter apparatus, to achieve different proportioning of the inlet fluid between the bypass and full-flow filters.

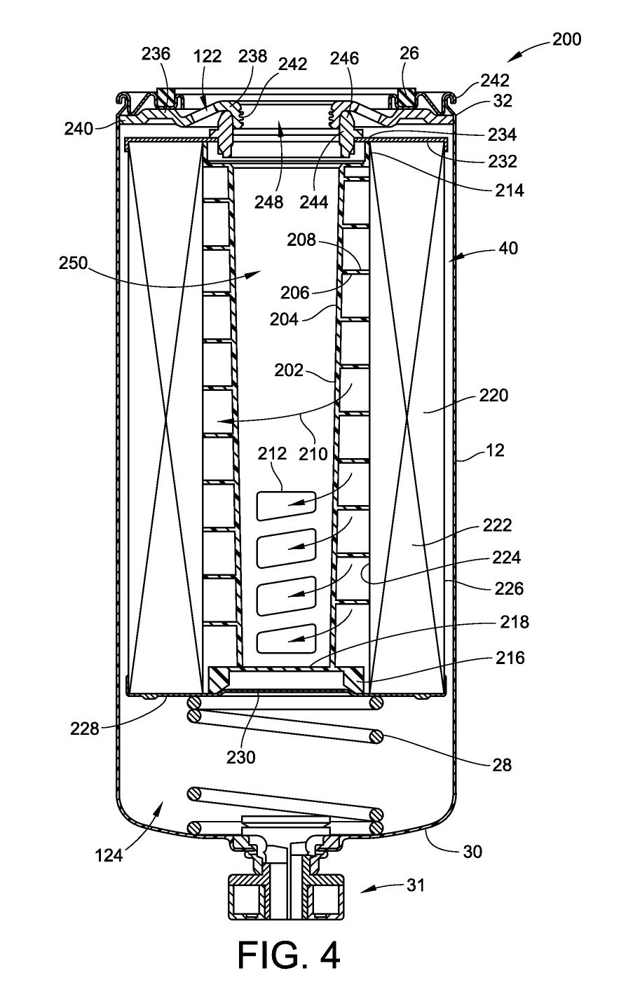

Referring to FIGS. 4-6, a second exemplary embodiment of a spin-on filter 200 is shown according to the invention, where the reference numbers previously described represent like features. Filter 200 includes a housing 12 enclosing a filter 220, a center tube 202, an inlet seal 26, and a helical compression spring 28. Housing 12 has a closed end 30 and an open end 32, joined by a cylindrical sidewall 34 defining a longitudinal axis extending from the closed end 30 to the open end 32 of the housing 12. Spin-on filter 200 is shown in a vertical mounting configuration, where closed end 30 is at the bottom of the filter 200 and the open end 32 is at the top of filter 200. However, spin-on filter 200 may be mounted in any orientation.

Filter 220 has a filter media 222, defining an inner periphery 224 and an outer periphery 226, a lower end plate 228, and an upper end plate 232. The lower end plate 228 of filter 220 is attached to the lower end of filter media 222. Lower end plate 228 includes a raised imperforate center section 230 which blocks fluid flow from entering the center bore 250 of the center tube 202. Upper end plate 232 of filter 220 is attached to the upper end of the filter media 222, extending generally inward from the outer periphery 226 of the filter 220, and terminating in a centrally located annular collar 234, defining an outlet 248 of the center bore 250 of the center tube 202.

Center tube 202 includes an annular wall 204, open top end 214, a bottom end 218, and a bottom support flange 216. Open top end 214 is positioned adjacent to upper end plate 232, and open top end 214 is in fluid communication with outlet 248. Bottom support flange contacts raised imperforate center section 230 of lower end plate 228, thereby centering center tube 202 with respect to filter 220. As shown, bottom end 218 of center tube 202 is an imperforate closed bottom end. In another embodiment, bottom end 218 may be open, and bottom support flange 216 may be coupled to center section 230. In one embodiment, the internal diameter of the annular wall 204 of center tube 202 increases slightly from a smaller diameter proximate to bottom support flange 216, to a larger diameter proximate to open top end 214. In other embodiments, annular wall 204 may have a generally constant internal diameter, or a diameter that decreases proximate to open top end 214.

Referring to FIG. 4, filter cartridges of the present invention may optionally be provided with a drain, shown as a drain valve 31. As shown, drain valve 31 is disposed within closed end 30 such that drain valve 31 is at the lowest point of spin-on filter 200, when spin-on filter 200 is mounted in the vertical configuration shown. Drain valve 31 is provided in a normally closed position. When removal or replacement of spin-on filter 200 is desired, fluid contents of the filter 200 may be drained via actuation of drain valve 31, thereby reducing spillage of fluid contents when spin-on filter 200 is removed. Drain valve 31 may be any type of valve known in the art, such as a ball valve, gate valve, or plug valve. Alternately, the drain may comprise a threaded opening and drain screw plug.

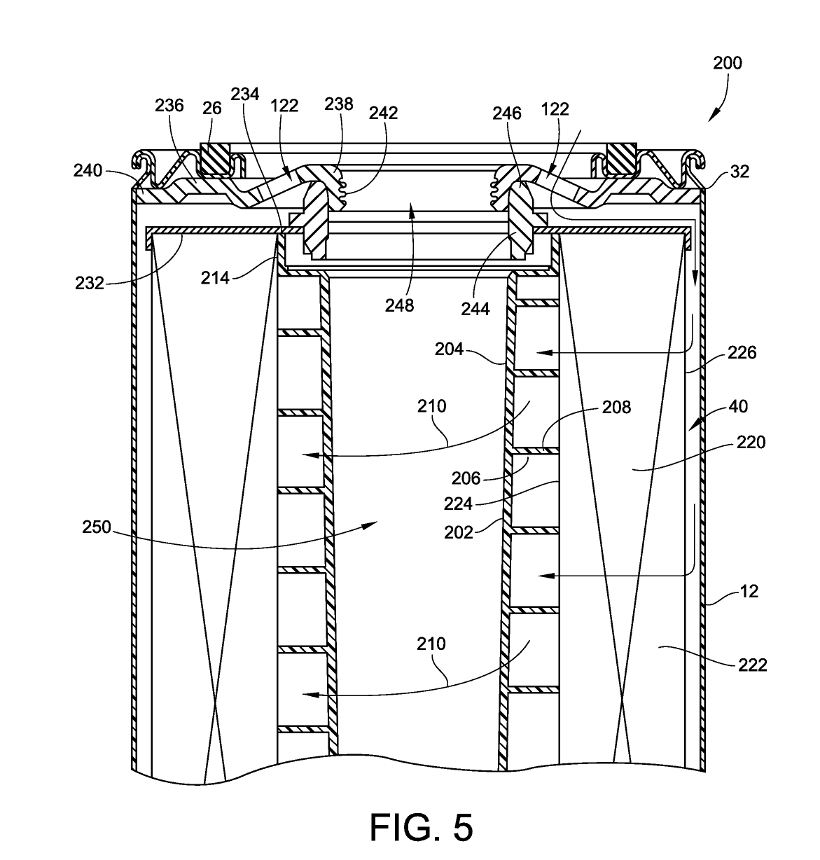

Referring to FIG. 5, an alternate mounting configuration for a spin-on filter cartridge is shown. Spin-on filter 200 is provided with a top plate 236 adjacent to open end 32 of filter housing 12. Outer edge 240 of top plate 236 is joined to sidewall 34 at open end 32 of housing 12. An inner edge 238 of top plate 236 is provided with threads 242 for engagement to a filter mounting adaptor, for attaching the spin-on filter 200 to a filter mounting adapter and sealing outlet 248 to the filter mounting adaptor. The inlet seal 26 seals the juncture of the open end 32 of the housing 12 with a seal surface when the spin-on filter 200 is attached to a mounting adapter.

Top plate 236 is provided with a plurality of circumferentially spaced inlet flow passageways 122 that provide fluid communication between inside and outside surfaces of the top plate 236. The inlet flow passageways 122 in the top plate 236, in combination, define a filter inlet that allows fluid to flow from a filter mounting adapter into the inlet plenum 114 of filter housing 12. Inlet plenum 114 of filter housing 12 is in fluid communication with space 40.

A center spacer 244 is sealingly coupled to the centrally located annular collar 234 of upper end plate 232. An upper edge 246 of center spacer 244 sealingly engages the inner edge 238 of top plate 236, thereby centering the center tube 202 within housing 12 and sealing inlet plenum 114 from outlet 248.

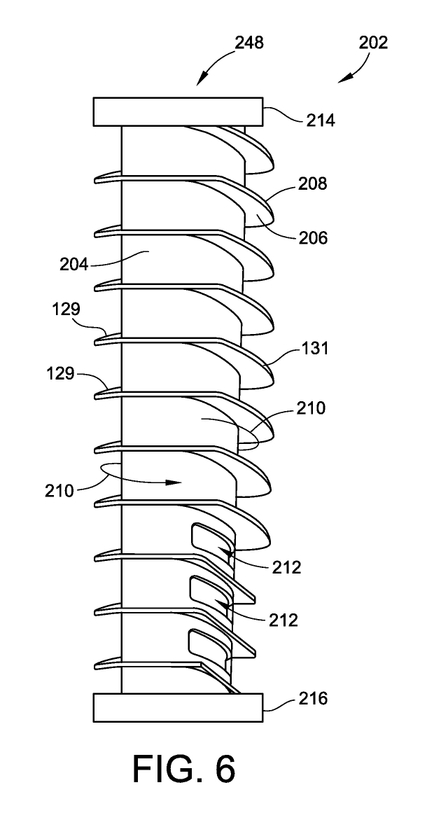

As best shown in FIG. 6, center tube 202 is provided with a helical fin 206 surrounding the outside of annular wall 204. Helical fin 206 of center tube 202 extends from the variable radial inner diameter of annular wall 204 to an outer edge 208 of helical fin 206. As shown, helical fin 206 of center tube 202 includes substantially flat portions 129, the substantially flat portions 129 being disposed generally perpendicular to the longitudinal axis of center tube 202, and helical fin 206 further includes sloped portions 131 connecting adjacent flat portions 129. In another embodiment, helical fin 206 may describe a substantially smooth curve having a constant slope.

Referring again to FIGS. 4-6, outer edge 208 of helical fin 206 is positioned at a constant radius from the longitudinal axis of housing 12, and adjacent to the inner periphery 224 of filter 220. Outside edge 208 of helical fin 206 radially contacts and supports the inner periphery 224 of filter 220, thereby supporting filter 220 against radially inward collapse in response to a fluid pressure differential between outer periphery 226 and inner periphery 224. The radial outward support provided by helical fin 206 to inner periphery 224 of the filter 220 reduces or eliminates the need for a separate support, such as a perforated center tube or an inner screen, located at the inner periphery 224 of filter 220.

Helical fin 206 defines a helical flow path 210 located between the inner periphery 224 of filter 220 and the annular wall 204 of center tube 202. Helical flow path 210 is in fluid communication with the flow inlets 212, thereby channeling fluid filtered through the filter 220 to the flow inlets 212. Flow inlets 212 provide fluid communication between the outside of annular wall 204 and the center bore 250 of the center tube 202.

In a preferred embodiment of the present invention, helical fin 206 is integrally formed with annular wall 204 of center tube 202. As shown, helical fin 206 is coextensive with the length of center tube 202 and continuously extends from the open top end 214 to the bottom support flange 216 of center tube 202, and helical fin 206 is generally imperforate. In other embodiments, helical fin 206 may be discontinuous and may be perforated, thereby providing both a helical flow path and other fluid flow paths.

In a preferred embodiment, center tube 202 is provided with a single helical fin 206. However, center tube 202 may alternately be provided with two or more helical fins, together defining two or more fluid flow paths, each providing fluid communication between inner periphery 224 of filter 220 and flow inlets 212. In such a configuration, a plurality of helical fins would form a double helix, triple helix, etc.

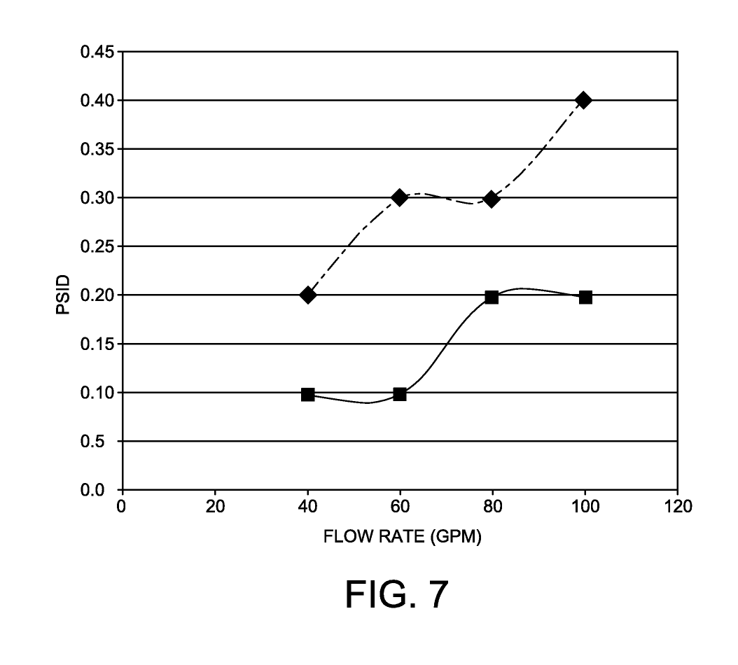

Referring to FIG. 7, the flow rate versus pressure for two filters are shown. Line 300 shows the flow rate versus pressure for a cartridge filter embodying the present invention, incorporating a center tube having a helical fin as shown in FIGS. 4-6. Line 302 shows the flow rate versus pressure for a filter incorporating a perforated support tube positioned at the inner periphery 226 of the filter media 224, and a separate center tube or standpipe 202. As shown, a reduction in flow restriction is obtained by the use of a center tube 202 having an integrated helical fin 206.

All references, including publications, patent applications, and patents cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) is to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A fluid filter assembly comprising:
a tubular ring of filter media;
a center tube, the center tube having an annular wall defining an internal axial flow passage, a flow inlet through the annular wall, and a first opening at an end of the center tube, wherein fluid is adapted to flow radially through the tubular ring of filter media, through the flow inlet, and along the internal axial flow passage; and
at least one fin integrally formed and unitary with the center tube and projecting radially outwardly from the annular wall, each of said at least one fin covering and in contact with the annular wall over an angular span about the axial flow passage of at least 30 degrees such that the at least one fin has an outer peripheral surface radially supporting an inner periphery of the tubular ring of filter media.

2. The fluid filter of claim 1, wherein each at least one fin acts as a flow baffle redirecting fluid angularly at least 30 degrees along an external flow passage formed along the outside of the center tube leading to the flow inlet.

3. The fluid filter of claim 2, wherein the at least one flow baffle defines a spiraling path for the external flow passage along an outside surface of the center tube.

4. The fluid filter of claim 3, wherein the at least one fin comprises a helical shape extending around the center tube multiple times.

5. The fluid filter of claim 1, wherein the at least one fin comprises at least two fins in spaced apart relation without additional intervening structure between the outer peripheries of the fins, the at least two fins being supported and indirectly connected through the material of the center tube.

6. The fluid filter of claim 5, wherein the at least two fins comprise a first fin on one axial side of the flow inlet and a second fin on another axial side of the flow inlet.

7. The fluid filter of claim 1, wherein the center tube comprises a flow divider that is at least one of a flow balancer and a venturi, wherein the center tube comprises a second opening at an end of the center tube opposite the first opening, a flow bypass being defined around the tubular ring of filter media through the second opening.

8. The fluid filter of claim 1, wherein the center tube and the at least one fin are a unitary plastic molded structure.

9. A fluid filter assembly comprising:
a first tubular ring of filter media, the first tubular ring of filter media having an inner diameter;
a center tube, the center tube having a wall defining a first center cavity, a flow inlet in the wall, and a first open end; and
a helical fin, the helical fin having an outer diameter configured to radially outwardly support the first filter media at the inner diameter, wherein the helical fin extends outward from the wall, and wherein the helical fin defines a helical fluid channel between the first filter media at the inner diameter and the flow inlet.

10. The fluid filter assembly of claim 9, wherein the center tube further comprises a closed end.

11. The fluid filter assembly of claim 9, wherein the helical fin forms a single helical flow channel between the first filter media and the flow inlet.

12. The fluid filter assembly of claim 9, wherein the center tube comprises a flow divider that is at least one of a flow balancer and a venturi, wherein the center tube comprises a second open end of the center tube opposite the first open end, a flow bypass being defined around the tubular ring of filter media through the second open end.

13. The fluid filter assembly of claim 12, wherein the helical fin extends around the center tube at least 360 degrees.

14. The fluid filter assembly of claim 12, wherein the center tube comprises an open bottom end and the fluid filter assembly further comprises:
a second filter media, the second filter media defining a second center cavity, wherein the second center cavity has an open top end, and wherein the open top end is in fluid communication with the second open end of the center tube;
a seal, the seal position between the first filter media and the second filter media; and
a bias spring, the bias spring configured to compress the seal between the first filter media and the second filter media.

15. The filter assembly of claim 9, wherein the filter is a spin-on filter further comprising:
a housing defining an open end, the open end configured for spin-on attachment to a filter mounting structure.

16. A fluid filter assembly comprising:
a tubular ring of filter media;
a center tube, the center tube having an annular wall defining an internal axial flow passage, a flow inlet through the annular wall, and a first opening at an end of the center tube, wherein fluid is adapted to flow radially through the tubular ring of filter media, through the flow inlet, and along the internal axial flow passage; and
at least two fins integrally formed and unitary with the center tube and projecting radially outwardly from the annular wall, the at least two fins in spaced apart relation without additional intervening structure between the outer peripheries of the fins, the at least two fins being supported and indirectly connected through the material of the center tube, and each of the at least two fins having an outer peripheral surface radially supporting an inner periphery of the tubular ring of filter media.

17. The fluid filter assembly of claim 16, wherein each of said fins covers and is in contact with the annular wall over an angular span about the axial flow passage of at least 30 degrees.

18. The fluid filter assembly of claim 17 wherein at least one of the fins acts as a flow baffle redirecting fluid angularly at least 30 degrees along an external flow passage formed along the outside of the center tube leading to the flow inlet.

19. The fluid filter of claim 16, wherein at least one of the fins comprises a helical shape extending around the center tube multiple times.

20. The fluid filter of claim 16, wherein the center tube comprises a flow divider that is at least one of a flow balancer and a venturi, wherein the center tube comprises a second opening at an end of the center tube opposite the first opening, a flow bypass being defined around the tubular ring of filter media through the second opening.
